(19) United States
(12) Patent Application Publication
(10) Pub. No.: US 2020/0070057 A1
(43) Pub. Date: Mar. 5, 2020

(54) METHOD AND SYSTEM FOR IMPROVED PLAYING OF DOMINO BOARD GAMES

(71) Applicants: Mikel Willis, Silsbee, TX (US); Mikel Willis, JR., Houston, TX (US); Tim Irving, Beaumont, TX (US)

(72) Inventors: Mikel Willis, Silsbee, TX (US); Mikel Willis, JR., Houston, TX (US); Tim Irving, Beaumont, TX (US)

(21) Appl. No.: 16/120,236

(22) Filed: Sep. 1, 2018

(51) Int. Cl. A63F 13/79; A63F 13/825; A63F 13/215; A63F 13/46; A63F 13/335; A63F 9/20

(52) U.S. Cl. CPC A63F 13/79; A63F 13/825; A63F 9/20; A63F 13/46; A63F 13/335; A63F 13/215

(57) ABSTRACT

The present invention automates the playing of the game of dominoes. This automation will allow players in different geographic locations to compete against each other in real-time as if the players were across the table from each other. This invention also captures the sites and sounds of the atmosphere during a domino game and transmits to sites and sounds to all of the contestants of a domino game. This new domino game overcomes the barrier of distance and allows players from around the country and around the world to compete against each other. This present invention also automates functions necessarily performed during a game which can include keeping score, determining if a domino play result in a score for that player and establishing a play timer to promote consistent and efficient flow during a domino game.

### FIELD OF THE INVENTION

This invention relates to a method and system for improving the play of a domino board game. In particular, this invention relates to an improved domino table for playing dominoes. This invention also related to a system that will enable domino players located in different geographic locations to interact and play against each other in the same game. This invention also relates to a system that will enable the players to communicate with each other in an audible and visual manner during the game.

### BACKGROUND

The game of dominoes is a family of board games played with rectangular “domino” tiles. Each domino is a rectangular tile with a line dividing its face into two ends or sections. Each end or section is marked with a number of spots or is left blank. In general, the number of spots can range from zero to six. For other sets if dominoes each section can have up to nine spots. FIG. 1 shows several dominoes from a set. Notice various dominoes with different numbers of spots on each end. The back faces of the dominoes in a set are indistinguishable. The backsides of the domino tiles are either blank or have some common design. Different geographic locations or cultures may refer to the domino gaming titles or dominoes by nicknames including bones, cards, tiles, tickets, stones, or chips. The domino tiles make up the domino set. The domino set is sometimes called a deck or pack.

A conventional game of dominoes is usually played on some form of flat surface such as a table. During the game, players must play a domino where one end section of the domino matches the uncovered end section of an already played domino. Matching end sections are sections in which the number of spots is the same for both dominoes. For example, if a played domino has an uncovered end section that has five spots, then any domino played on that uncovered end must have five spots. Once played, the newly played domino now becomes the end with an uncovered end section having a certain number of spots on that end section. After a domino is played the total number of spots for end sections for all uncovered are counted.

In addition to the mechanics of playing the game, another aspect of the game is the game atmosphere. In some cultures, a major part of the game is the interaction between the players or contestants. The back and forth talking between the players adds to the game atmosphere and intrigue. These conversations are a form of “trash talking” between players that is common in many competitive events. This activity can also be part of a player's strategy during a game to rattle or unnerve an opponent. Also, how one plays a domino can also be a statement-making act. In some cultures, slamming a domino onto the table and taking a count can be a way of conveying confidence or excitement about a player's chances of winning a game. It can be a form of celebration similar to spiking a football.

Another activity that is part of domino playing is keeping score. During the game, players call out their scores as they play the dominoes. One person is the designated scorekeeper. This person can be one of the players or it can be a person not participating in the game. The important aspect is that the scorekeeper has to be alert to players calling counts in order to not miss a call deny a player their points.

Domino playing on Skype provides some means to capture voice sounds during a game. However, there are limitations to capturing visual images beyond the domino table.

Although the game of dominoes is a great game, with the technological advances, the game has the potential to become even more enjoyable. There remains a need to enhance the game dominoes through technology that would bring welcomed improvements to the game.

### SUMMARY

This present invention provides improvements to the playing of the game of dominoes. This present invention enhances the experience of playing dominoes by automating some one the domino playing mechanics and by capturing some of the domino playing atmosphere that is lost when one plays dominoes on computing machine. During games, the players interact with other and in many instances use cultural sayings or phrases to convey the significance of a particular domino play. Players may also use various types of gestures during the game that add to the interaction, atmosphere and game. The verbal and physical activities are part of the domino game and enhance the domino game experience.

The present invention also provides for persons to compete in a domino game from different geographic locations. Players in different locations can connect to the system of the present invention, view a domino playing surface from a system screen, make domino plays and hear and see the other players during the game. This system enables the players to communicate and interact with each other in real time while playing. This feature enables the players to experience the atmosphere of the game.

The present invention can facilitate many of these enhancements through a modified domino table. This table can have the capability to monitor the domino board, detect various dominoes being played and determine when a player has a score.

### DESCRIPTION OF THE DRAWINGS

FIG. 1 is a view of typical domino tiles used in a conventional game of dominoes.

FIG. 2 is a view of a configuration for playing a domino game, in which at least one of the players is geographically located at a remote site away from the actual site of the game,

FIG. 3 is a view of a pattern record for end sections of a domino.

FIGS. 4a-4d are views of front and back of a domino according with an embodiment of the present invention.

FIG. 5 is a general flow diagram for implementation of the present invention.

FIG. 6 is a detailed flow diagram for implementation of the present invention.

FIG. 7 is a system configuration of the virtual domino game of the present invention.

FIG. 8 is a flow diagram of the steps in the implementation of the virtual domino game of the present invention shown in FIG. 7.

FIG. 9 is a configuration for portable domino game of the present invention.

FIG. 10 is a configuration for a smart domino table of the present invention.

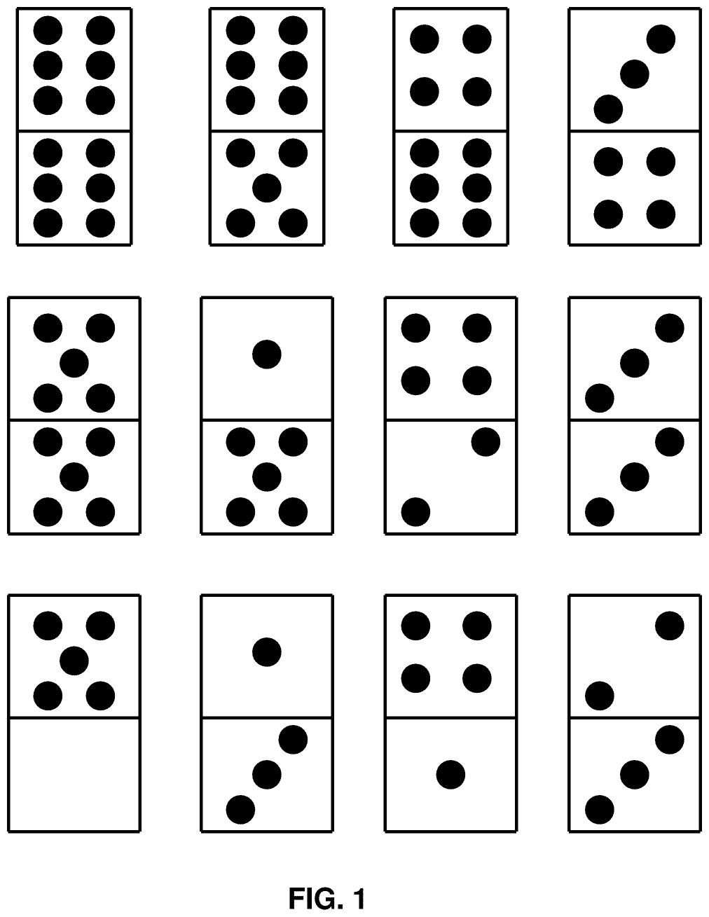

### DESCRIPTION OF THE INVENTION

One goal of this invention is to enhance the domino experience by capturing game atmosphere and implementing automated game features. In an embodiment of the present invention, the playing table contains a flat surface and a sensor system that can detect specific dominoes. Referring to FIGS. 4a through 4d, the dominoes can have the conventional front surfaces as previously described and shown in FIGS. 4a and 4c. However, the back surfaces, FIGS. 4b and 4d, can have a magnetic strip as shown that contains information that will enable the sensing system to identify the specific domino. In addition to detecting when a domino is played and identifying the played domino, this embodiment has the capability to determine open-end sections of played dominoes and determine if the total spots of the detected end sections is a number that is a multiple of 5. If so, the player playing the last domino would be entitled to points that equal the number of counted spots on these open-end domino sections. Even though the present invention has the capability to identify scores and the player entitled to the points, the player still has to claim these points before receiving them. This embodiment can also have a form of play timer feature. A player would have a defined time period to play a domino. If the player fails to play a domino in that time period, the player could lose a turn or possible lose points. This feature encourages efficient playing of dominoes and also rewards skill in playing dominoes.

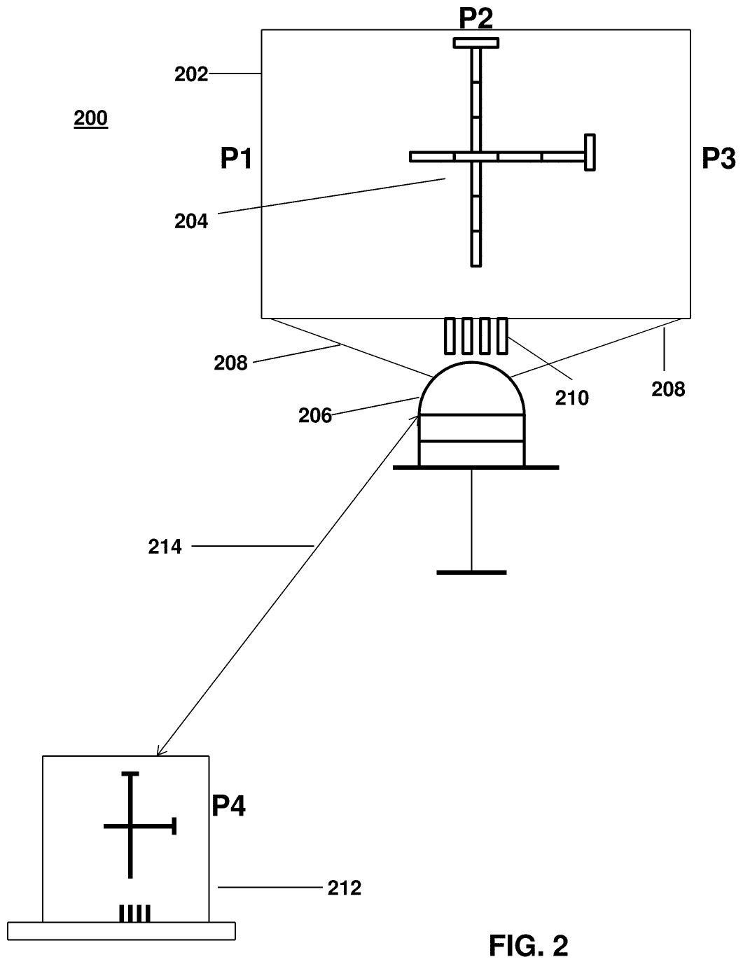

Referring to FIG. 2, shown is a configuration 200 of an embodiment of the present invention the enables a player at a different geographic location to participate in the domino game. The domino player surface (table) 202 shows a typical configuration of dominoes 204 during a round in a domino game. Players P1, P2 and P3 are present at the domino table. Player P4 is at a different geographic location. A camera device 206 captures a range 208 of the table 202. This captured image includes the dominoes 210 for player P4. The camera transmits this image via a communication link 214 to a display device at the location of P4. As shown, the display device 212 shows the image of the board and P4's available dominoes at the P4 location. In addition to the visual images, the camera device 206 also transmits audible sounds from the domino table location. With these sounds, player for can see and hear the action at the table.

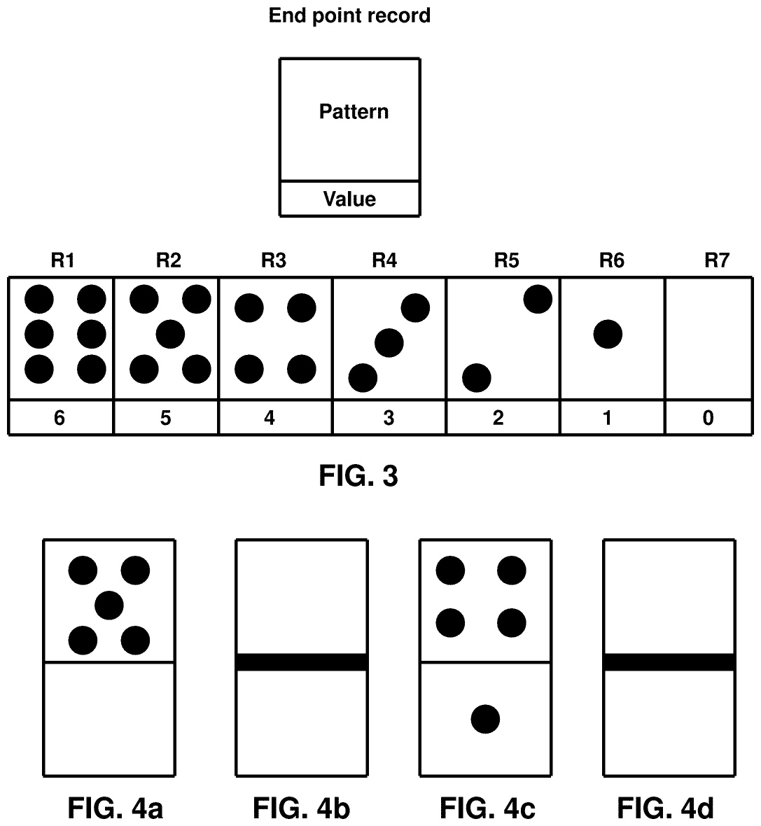

FIG. 3 shows a configuration of a record stored in a database for each end section of a domino. The domino record can have at least two fields that contain the domino spot pattern and a numerical value for that spot pattern. These records can be stored in a database and used to different domino tiles and section values.

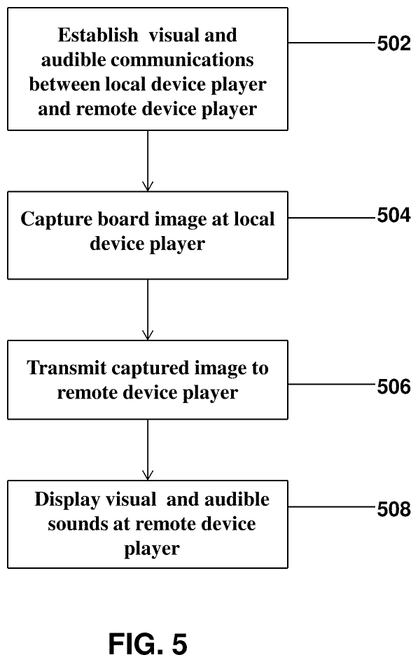

FIG. 5 illustrates a general flow diagram of the method of the present invention as shown in FIG. 2. In this method step 502 establishes visual and audible communications between the device 206 at the location of the domino game and remote player device 212. Step 504 captures a board image of the table 202 at the location of the domino game. The next step 506 transmits the captured images to the device 206 at the remote location of the player. Step 508 displays visual image and audible sounds at remote location.

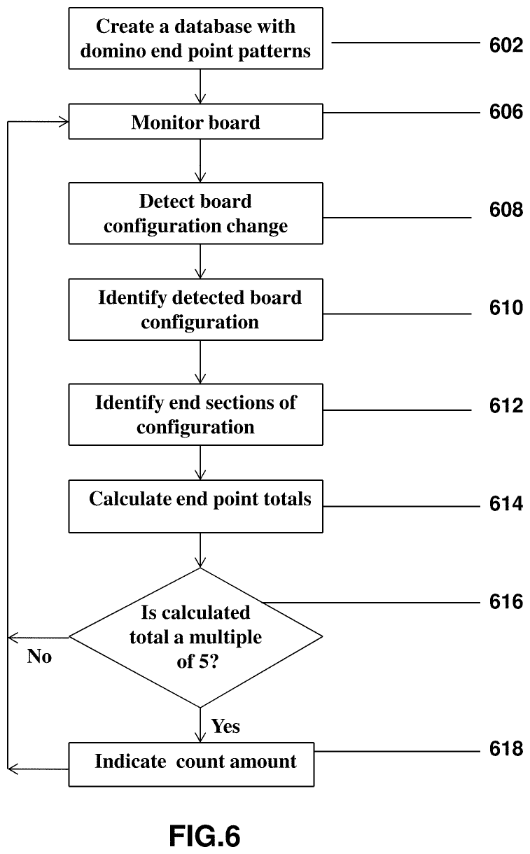

FIG. 6 shows a more detailed flow design for an embodiment of the present invention. In this method, step 602 creates a database with records for domino end section patterns as shown in FIG. 3. At this point, the game begins and step 606 monitors the board for player activity. Step 608 detects a change in the board configuration. This change will occur after a player has played a domino. In step 610, the board configuration is identified. The next step 612 then identifies uncovered end sections of the identified configuration. Step 614 calculates the uncovered end section totals. At this point, step 616 determines if the calculated total is a multiple of 5. If the determination is that the calculated total is a multiple of 5, step 618 indicates a count amount. However, this step will not credit this count to the player. If in step 616, the calculated total is not a multiple of 5, then the method moves to back to step 606 and monitors the board for the next player activity.

As mentioned, this invention seeks to enhance the playing of the domino game and capture the atmosphere of around the domino table. With the advancement in technology, there has been the creation of online domino games that people play on their computers. In some of these games, a player plays against the computer. In other games, other live players can compete against each other. Although these electronic and online games are an advancement, these games are not still able to capture the game time atmosphere around the domino table.

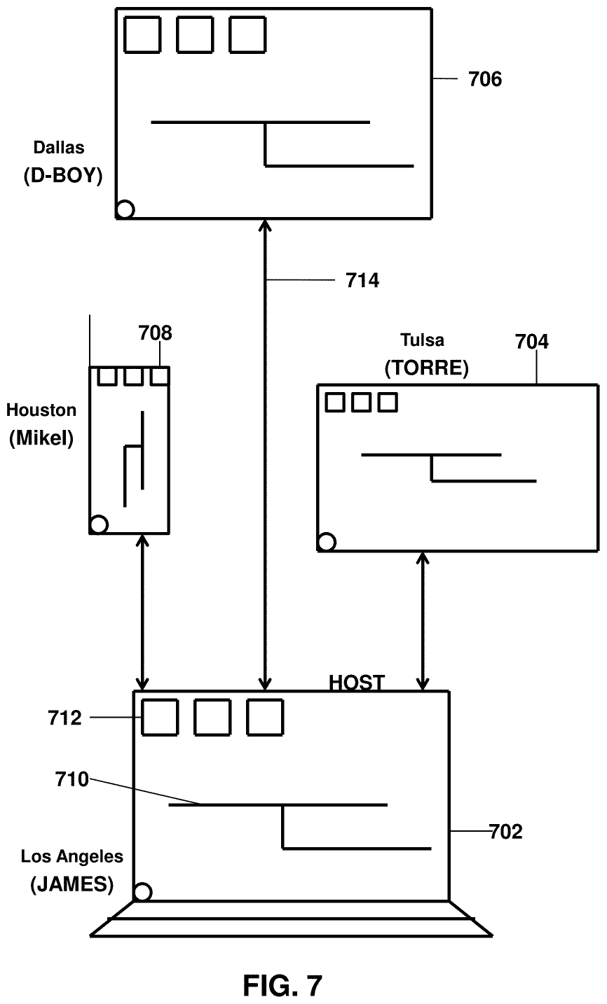

An embodiment of the present invention provides a means to capture the atmosphere around the domino board and enable a player at a different geographic location to experience the excitement of the game as if that player was physically located at the domino table. FIG. 7 shows a configuration where players in different geographic locations can compete against each other while capturing the atmosphere of players when they are across the table or adjacent each other. In this configuration, one location 702 serves as host for the particular game. This host location contains the software that facilitates the playing of the game. The host machine could also be a central server machine to which all of the players in the game can connect to play. In this configuration, the game has four players with each player in a different geographic location. Player James is the host for the game. He is located in Los Angeles. Player Torre is located in Tulsa and uses device 704 to connect to the game. The device 704 can be any type of computing device such as a laptop or tablet device. Player D-Boy located in Dallas connects to the game through electronic computing device 706. Player Mikel located in Houston can use a smart phone device 708 to connect to the game. In this system, each player screen shows the configuration 710 of the dominoes being played during the game. Each player has a set of images 712 of the other players appearing on their screens. With these images, the players have some form visual communication of the other players. In addition to the visual images, each player has the capability to verbally communicate with the other players via speakers and microphones on the player devices. The different devices communicate with the host and each other via communication links 714. These links transmit the sound and visual images of the game, which helps to create the game atmosphere. In addition, these links connect the players to the game software located in the host device 702.

In the embodiment, players would use headsets and hand devices to participate in the game. Each player would access via a network connection a software version of the domino game. As mentioned, the actual game software could be housed or loaded onto a console at one of the players. This console could be referred to as the host console. The other players would also connect to a console and access the game through that console. During the game, each player would have the capability to see the board via a screen connected to the console in the same manner as other video games. Real time images of each player would also appear on the screens of the other players. Sounds of the actions of the actions of the players could be heard on the headsets or listening devices of the other players. In this way, players could play a game of dominoes with players being in remote locations and experience the atmosphere of the game as if each player was face to face with the other players. This capability is currently not available on existing electronic domino game systems.

This embodiment can also incorporate avatar like concepts and features to the game. Domino players can select a particular character to be during the game. Also included can be certain commands and gestures enacted by players for their particular characters. For example, when it is a particular player's turn, the character for the player can make a certain gesture such as a slamming gesture and sound to play the domino. The other players can see the domino board and as a result can see the gesture and hear the sound of the character (player) playing the domino.

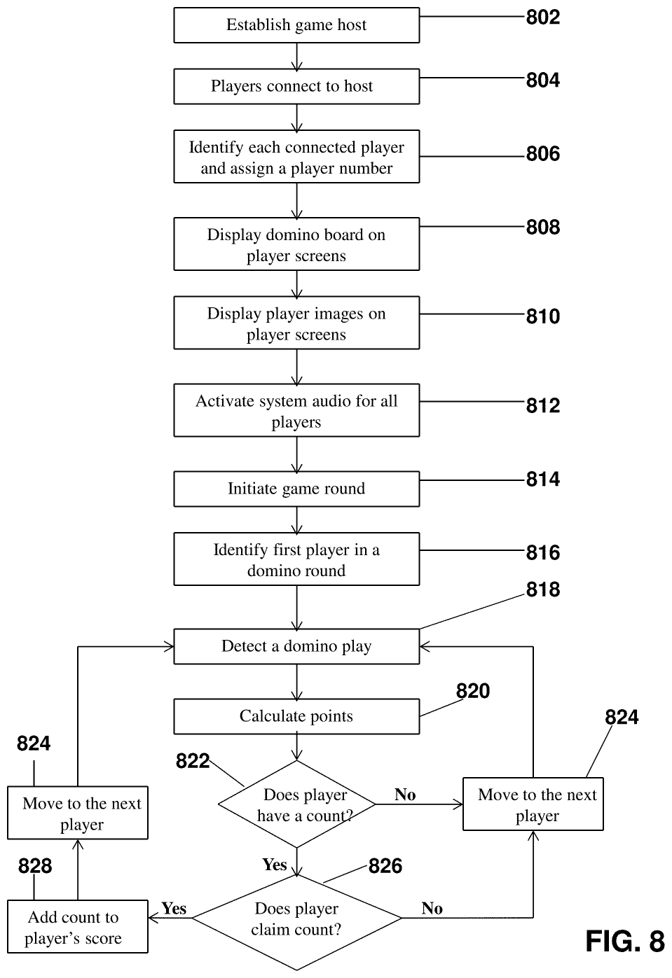

FIG. 8 shows a flow diagram of the steps in the virtual game embodiment of the present invention shown in FIG. 7. In this process, step 802 establishes the game host machine and executes the game software. The players would use electronic devices to connect the host computer in step 804. In step 806, the process identifies each player connected to the system. This step also assigns each player a number. As the game begins, step 808 displays the domino board on the screen of each player in real time. Step 810 also displays the images of the players on the screens of the other players. As a result, each player can see the other players in the game. Step 812 activates the sound. As mentioned, this ability to see and hear the other players helps bring in the atmosphere of the game. Step 814 initiates the round in a game. As part of this process, step 816 identifies the first player to play a domino at the beginning of a round. As the game progresses, step 818 detects a domino play. Each player sees the play on the player's screen. Step 820 calculates the total number of points that results from the play to determine if the player has scored any points as a result of the domino play. As part of the score determination, step 822 identifies all of the uncovered end sections of the dominoes played on the board. If the count is a multiple of five (5) the player has a score. If the player does not have a count, the game moves to the next player in step 824 and the process returns to step 818 and continues the process for the next player. If in step 822, the determination is that the player does have count, step 826 determines if the player claims the count. If the player does not claim the count, the process moves to the next player in step 824. If in step 826, the player does claim the score, step 828 adds the score to that player's total score and moves on the next player in step 826. The process then returns to the next player at step 818. Referring back to step 818, once the process detects a domino play, a timer can initialize and began count for the next player to play a domino. If the timer counts down to zero (0) and the player has not played a domino, that player could lose their turn to play. The amount of time a player has to play a domino can be set as part of the pregame initialization.

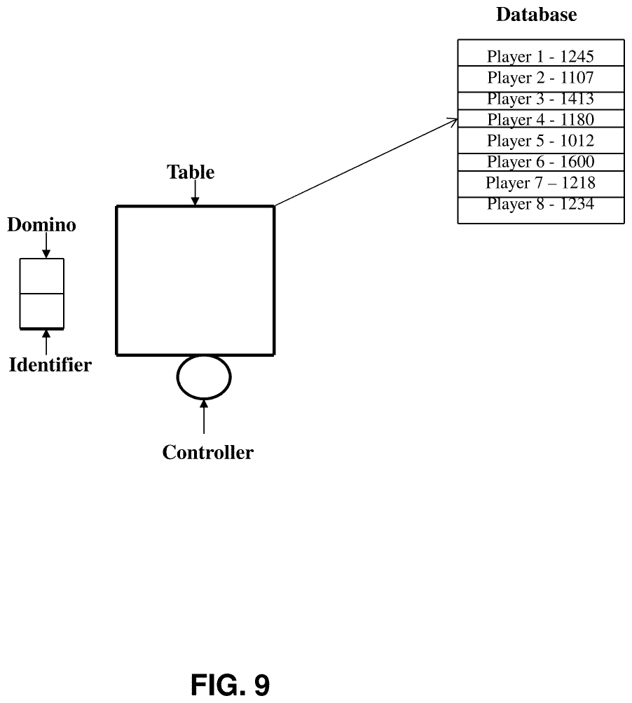

FIG. 9 is a configuration for portable domino game of the present invention. This embodiment can facilitate automated domino playing in accordance with the present invention. This embodiment contains a controller, dominoes with an identifier and the ability to link to and communicate with database. The controller contains the software for operating of the game, sensors to identify a specific domino and the capability to link to a database in a remote location from the controller. The software in the controller also has the ability to identify player positions (the player playing a particular domino), set the time for a player to play a domino and identify when a player has a score or count. When a player plays a domino, the controller of the present invention can detect the play and identify the played domino and the location on the table of the played domino. As a result, the controller can create an ongoing image and configuration of the played dominoes on the table. The controller has the capability to monitor domino play and keep the score for each player. A major advantage of this embodiment of the present invention is its portability. Players can take this system and implement automated domino play on any table.

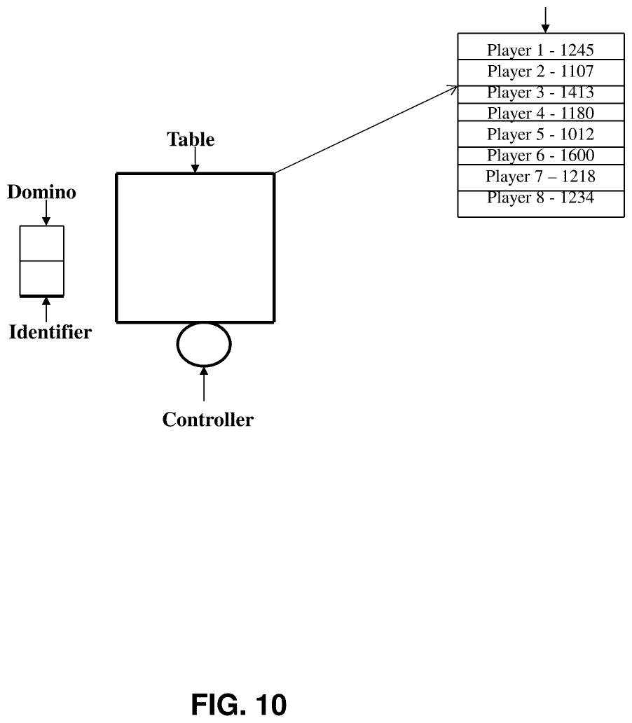

FIG. 10 is a configuration for a smart domino table of the present invention. This embodiment incorporates the features and capabilities of the system described in FIG. 9 into an actual domino table. The incorporation of this system converts the domino table of FIG. 10 a smart domino table.

The present invention has the technology and potential to evolve into and initial a board gaming industry for dominoes. The implementation of gaming software and actual domino table designs provide for an enhanced game experience. Automated domino playing in accordance with the present invention has the potential to grow into an industry in a manner such as poker.

While the present invention has been illustrated by the description of embodiments thereof, and while the embodiments have been described in some detail, it is not the intention of the applicant to restrict or in any way limit the scope of the invention to such details. Additional advantages and modifications will readily appear to those skilled in the art. The invention in its broader aspects is not limited to the specific details, representative apparatus and methods, and illustrative examples shown and described. Accordingly, departures may be made from such details without departing from the spirit or scope of the applicant's general inventive concept.

1. An automated system for playing the game of dominoes comprising:
a set of domino tiles, each tile having a front surface with two sections, each section having a number of spots, said domino tiles also having a unique identifier, attached to each of the domino tiles, that conveys the number of spots on each section of the domino tile;
one or more sensors capable of identifying each domino in the set of dominoes;
a controller module containing software routines capable of:
identifying domino players in a game;
detecting a domino play during a game;
calculating points resulting from the detected domino play; and
determining when calculated points results in a score for the player playing the domino; and
a database of domino players containing a player identity and a player point total, said domino database being accessible by said controller module software.

2. The automated system for playing dominoes as described in claim 1 wherein said controller operates a domino game according to established domino rules.

3. The automated system for playing dominoes as described in claim 1 further comprising a table for playing dominoes wherein said controller module is positioned on or in close proximity to the table.

4. The automated system for playing dominoes as described in claim 3 further comprising a domino play timer that defines the amount of time each player has to play a domino during a game.

5. The automated system for playing dominoes as described in claim 3 further comprising a point display indicating the scores for each player in the domino game and indicating the players who has the next turn to play a domino.

6. An automated system for playing the game of dominoes when the domino players are in multiple geographic locations comprising:
a computing network
a host computing device for facilitating playing dominoes over a computing network;
a plurality of computing devices connected to the host computing device to be used to facilitate multi-player domino games;
display screens on each device;
a controller module that operates a domino game according to established domino rules and containing software routines capable of:
identifying domino players in a game;
displaying player images on a screen of each computing device of a player in the game;
detecting a domino play during a game;
calculating points resulting from the detected domino play; and
determining when calculated points results in a score for the player playing the domino; and
a database of domino players containing a player identity and a player point total, said domino database being accessible by said controller module software.

7. The automated system for playing the game of dominoes as described in claim 6 wherein said plurality of computing devices further comprises the capability to capture and transmit in real-time audible sounds and visual images such that the computing devices of other players in the game can receive the audible sounds and visual images.

8. The automated system for playing the game of dominoes as described in claim 6 wherein said plurality of computing devices further comprises the capability to receive in real-time audible sounds and visual images from the computing devices of other players in the game.

9. The automated system for playing the game of dominoes as described in claim 8 wherein said plurality of computing devices further comprises the capability to display image representations of each player in the game.

10. The automated system for playing the game of dominoes as described in claim 6 wherein said controller module further comprises an internal index of stored domino game sounds, the sounds comprising voice sounds in the form of words and phrases and object sounds.

11. The automated system for playing the game of dominoes as described in claim 10 further comprising sound recognition software for detecting said voice sounds in real-time and broadcasting the detected sounds to all players.

12. The automated system for playing the game of dominoes as described in claim 6 wherein said host computing device comprising a central server device connected to and in communication with each of said plurality of computing devices used to facilitate multi-player domino games.

13. An automated method for playing the game of dominoes when the domino players are in multiple geographic locations comprising the steps of:
identifying domino players in a game;
displaying player images on a screen of each computing device of a player in the game;
detecting a domino play during a game;
calculating points resulting from the detected domino play; and
determining when calculated points results in a score for the player playing the domino; and
when calculated points result in a score for the player playing the domino, updating a score for that player.

14. The automated method for playing the game of dominoes described in claim 13 further comprising in said detecting step;
identifying which player made the domino play;
detecting any sounds during the play;
matching any detected sound with sounds from a an internal index of stored domino game sounds, the sounds comprising voice sounds in the form of words and phrases and object sounds; and
broadcasting a sound from the internal index of stored domino game sounds when a sound match occurs between a detected sound and an indexed sound.

15. The automated method for playing the game of dominoes described in claim 14 further comprising after said detecting a domino play during a game, starting a play timer and counting down time from an established threshold time for the next player to make a domino play.

16. The automated method for playing the game of dominoes described in claim 13 further comprising displaying on each screen of a domino player in the game, an image of the current configuration of dominoes that have been played during the game.

17. The automated method for playing the game of dominoes described in claim 13 further comprising creating a player database of domino players, said database having profile for each player a profile the player profile containing the player name identifier, a cumulative score and a player level.

18. The automated method for playing the game of dominoes described in claim 17 further comprising at the completion of a domino game:
determining a player score for that game;
transmitting that determined score to said player database; and
updating a cumulative score for a player at the player database.

19. The automated method for playing the game of dominoes described in claim 13 wherein said identifying domino players in a game further comprising allowing a domino player to select a character that will represent the domino player during the game, the domino character capable of performing movements and gestures for the represented player as indicated by said player and in accordance to activities during the game.

20. The automated method for playing the game of dominoes described in claim 13 wherein characters selected by the domino players can be Avatar characters.
